(19) United States
(12) Patent Application Publication
(10) Pub. No.: US 2014/0375777 A1
(43) Pub. Date: Dec. 25, 2014

(54) THREE-DIMENSIONAL INTERACTIVE SYSTEM AND INTERACTIVE SENSING METHOD THEREOF

(71) Applicant: UTECHZONE CO., LTD., New Taipei City (TW)

(72) Inventors: Yi-Wen Chen, New Taipei City (TW); Chieh-Yu Lin, New Taipei City (TW)

(73) Assignee: UTECHZONE CO., LTD., New Taipei City (TW)

(21) Appl. No.: 14/155,362

(22) Filed: Jan. 15, 2014

(30) Foreign Application Priority Data
Jun. 21, 2013 (TW) 102122212

(51) Int. Cl. H04N 13/02; G06F 3/14

(52) U.S. Cl. CPC H04N 13/0221; G06F 3/14
USPC 348/50

(57) ABSTRACT

A three-dimensional (3D) interactive system and an interactive sensing method are provided. The 3D interactive system includes a display unit, an image capturing unit and a processing unit. The display unit is configured to display a frame on a display area, and the display area is located on a display plane. The image capturing unit is disposed at a periphery of the display area. The image capturing unit captures images along a first direction and generates an image information accordingly, and the first direction is not parallel to a normal direction of the display plane. The processing unit detects a position of an object located in a sensing space according to the image information, and executes an operational function to control the display content of the frame according to the detected position.

### CROSS-REFERENCE TO RELATED APPLICATION

This application claims the priority benefit of Taiwan application serial no. 102122212, filed on Jun. 21, 2013. The entirety of the above-mentioned patent application is hereby incorporated by reference herein and made a part of this specification.

### BACKGROUND OF THE INVENTION

1. Field of the Invention

The invention relates to an interactive sensing technology, and more particularly to a three-dimensional interactive system and an interactive sensing method thereof.

2. Description of Related Art

In recent years, researches for non-contact type human-machine interactive system (i.e., a three-dimensional interactive system) have been rapidly grown. In comparison to a two dimensional touch device, the three-dimensional interactive system can provide somatosensory operations more close to senses and actions of a user in daily life, so that the user can have a better controlling experience.

Generally, the three-dimensional interactive system utilizes a depth camera or a 3D camera to capture images having depth information, so as to build up a sensing space in three-dimension according to the depth information being captured. Accordingly, the three-dimensional interactive system can execute corresponding operations by detecting the actions of the user in the sensing space, so as to achieve a purpose of spatial 3D interaction.

In conventional three-dimensional interactive systems, the depth camera and the 3D camera can only be disposed facing the user (i.e., along a display direction of a display), so that positions of the actions being detected can correspond to positions on a display screen. However, the depth camera and the 3D camera both have a maximum range for capturing images, thus the user can only perform controlling operations at specific regions in front of the depth camera. In other words, in the conventional three-dimensional interactive systems, the user cannot perform the controlling operations in regions adjacent to the display.

### SUMMARY OF THE INVENTION

The invention is directed to a three-dimensional interactive system and an interactive sensing method thereof, capable of detecting controlling operations of a user in areas near a display area.

The three-dimensional interactive system of the invention is configured to control a display content of a frame of a display unit. The display unit includes a display area for displaying a frame, and the display area is located on a display plane. The three-dimensional interactive system includes an image capturing unit and a processing unit. The image capturing unit is disposed at a periphery of the display area. The image capturing unit captures images along a first direction and generates an image information accordingly, and the first direction is not parallel to a normal direction of the display plane. The processing unit is coupled to the display unit and the image capturing unit, and configured to detect a position of an object located in a sensing space according to the image information and execute an operational function to control the display content of the frame according to the position being detected.

In an embodiment of the invention, an included angle between the first direction and the normal direction falls within an angle range, and the angle range is decided based on a lens type of the image capturing unit. For instance, the angle range is 45 degrees to 135 degrees.

In an embodiment of the invention, the processing unit defines the sensing space related to a size of the display area according to correction information, and the sensing space is divided into a first sensing region and a second sensing region along the normal direction of the display plane.

In an embodiment of the invention, the processing unit detects whether the object enters the sensing space, and obtains a connected blob based on the object that enters the sensing space.

In an embodiment of the invention, the processing unit determines whether an area of the connected blob is greater than a preset area, calculates a representative coordinate of the connected blob if the processing unit determines that the area of the connected blob is greater than the preset area, and converts the representative coordinate into a display coordinate of the object relative to the display area.

In an embodiment of the invention, the processing unit determines whether the object is located in the first sensing region or the second sensing region according to the representative coordinate, thereby executing the corresponding operational function.

In an embodiment of the invention, the processing unit filters a non-operational region portion in the image information according to a background image, and obtains the sensing space according to the image information being filtered.

In an embodiment of the invention, the image capturing unit is, for example, a depth camera, the image information obtained is, for example, a grey scale image. The processing unit determines whether a gradation block is existed in the image information, filters the gradation block, and obtains the sensing space according to the image information being filtered.

The interactive sensing method of the invention includes the following steps. A plurality of images are continuously captured along a first direction and an image information of each of the images is generated accordingly. The first direction is not parallel to a normal direction of a display plane, and a display area is located on the display plane for displaying a frame. A position of an object located in a sensing space is detected according to the image information. An operational function is executed to control the display content of the frame according to the position being detected.

In an embodiment of the invention, an included angle between the first direction and the normal direction falls within an angle range, and the angle range is decided based on a lens type of the image capturing unit. For instance, the angle range is 45 degrees to 135 degrees.

In an embodiment of the invention, before the position of the object located in the sensing space is detected, the sensing space related to a size of the display area is defined according to a correction information, and the sensing space is divided into a first sensing region and a second sensing region along the normal direction of the display plane. Further, in the step of detecting the position of the object in the sensing space, whether the object enters the sensing space is detected according to the image information. In addition, a connected blob is obtained based on the object that enters the sensing space when the object that enters the sensing space is detected, and whether an area of the connected blob is greater than a preset area is determined. If the connected blob is greater than a preset area, a representative coordinate of the connected blob is calculated, and the representative coordinate is converted into a display coordinate of the object relative to the display area.

In an embodiment of the invention, after the representative coordinate of the connected blob is calculated, whether the object is located in the first sensing region or the second sensing region is determined according to the representative coordinate, thereby executing the corresponding operational function.

In an embodiment of the invention, before the position of the object located in the sensing space is detected according to the image information, the method further includes: after an initial image information is obtained, a non-operational region portion in the image information is filtered, and the sensing space is obtained according to the image information being filtered.

In an embodiment of the invention, in case the image capturing unit is a depth camera, the image information obtained is a grey scale image. Accordingly, in the step of filtering the non-operational region portion in the image information, whether a gradation block (i.e., the non-operational region portion) is existed in the image information is determined, and the gradation block is then filtered.

Based on above, a three-dimensional interactive system and an interactive sensing method are provided according the embodiments of the invention. In the three-dimensional interactive system, the image capturing unit is disposed at a periphery of the display area to capture images near the display area, thereby detecting the position of the object. Accordingly, the three-dimensional interactive system is capable of effectively detecting the controlling operations of the user in the areas closing to the display area, for improving limitation of controlling distance in conventional three-dimensional interactive system, such that an overall controlling performance can be further improved.

To make the above features and advantages of the disclosure more comprehensible, several embodiments accompanied with drawings are described in detail as follows.

### BRIEF DESCRIPTION OF THE DRAWINGS

FIG. 1A is a schematic diagram illustrating functional blocks of a three-dimensional interactive system according to an embodiment of the invention.

FIG. 1B is a schematic diagram illustrating a configuration of a three-dimensional interactive system according to an embodiment of the invention.

FIG. 2 is a flowchart of an interactive sensing method according to an embodiment of the invention.

FIG. 3 is a flowchart of an interactive sensing method according to another embodiment of the invention.

FIG. 4A to FIG. 4F are schematic diagrams illustrating operations of a three-dimensional interactive system according to an embodiment of the invention.

### DESCRIPTION OF THE EMBODIMENTS

A three-dimensional interactive system and an interactive sensing method are provided according the embodiments of the invention. In the three-dimensional interactive system, images may be captured along a direction perpendicular to a normal direction of a display plane for detecting a position of an object, so that the three-dimensional interactive system can effectively detect controlling operations of a user in regions adjacent to a display screen. In order to make content of the present disclosure more comprehensible, embodiments are described below as the examples to prove that the present disclosure can actually be realized. Moreover, elements/components/steps with same reference numerals represent same or similar parts in the drawings and embodiments.

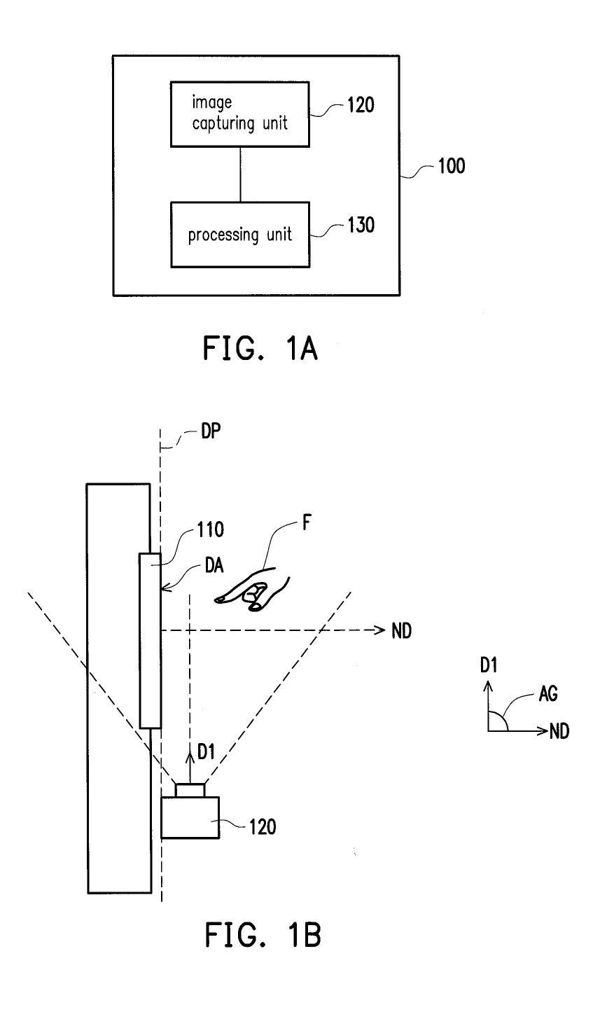

FIG. 1A is a schematic diagram illustrating functional blocks of a three-dimensional interactive system according to an embodiment of the invention. FIG. 1B is a schematic diagram illustrating a configuration of a three-dimensional interactive system according to an embodiment of the invention.

In FIG. 1A, a three-dimensional interactive system 100 includes an image capturing unit 120 and a processing unit 130. The three-dimensional interactive system 100 is utilized to control a frame displayed in a display unit 110 depicted in FIG. 1B. The display unit 110 is configured to display the frame on a display area DA. The display area DA is located on a display plane DP. In the present embodiment, the display unit 110 can be any type of display, such as a flat-panel display, a projection display or a soft display. In case the display unit 110 is the flat-panel display such as a liquid crystal display (LCD) or a light emitting diode (LED), the display plane DP refers to, for example, a plane corresponding to a display area on the display. In case the display unit 110 is the projection display, the display plane DP refers to, for example, a projection plane corresponding to a projected frame. Furthermore, in case the display unit 110 is the soft display, the display plane DP is capable of being bended together with display unit 110 to become a curved plane.

The image capturing unit 120 is disposed at a periphery of the display area DA. The image capturing unit 120 captures images along a first direction D1 and generates an image information accordingly to the processing unit 130. The first direction D1 is not parallel to a normal direction ND of the display plane DP. Therein, an included angle between the first direction D1 and the normal direction ND falls within an angle range, and the angle range is decided based on a lens type of the image capturing unit 120. The angle range is, for example, 90°±θ, and θ is decided based on the lens type of the image capturing unit 120. For instance, θ is greater when wide-angle of the lens being greater. For example, the angle range is 90°±45°, namely, 45° to 135°; or the angle range is 90°±30°, namely, 60° to 120°. Further, the included angle between the first direction D1 and the normal direction ND is more preferably to be 90°.

In the present embodiment, the first direction D1 is substantially perpendicular to the normal direction ND of the display plane DP. That is, an included angle AG between the first direction D1 and the normal direction ND is substantially in 90°. The image capturing unit 120 can be, for example, a depth camera, a 3D camera having a multiple lenses, a combination of multiple cameras for constructing a three-dimensional image, or other image sensors capable of detecting three-dimensional space information.

The processing unit 130 is coupled to the display unit 110 and the image capturing unit 120. The processing unit 130 performs image process and analysis according to the image information generated by the image capturing unit 120, so as to detect a position of an object F (e.g., a finger or other touching mediums), and control the frame displayed by the display unit 110 according to the position of the object F. In the present embodiment, the processing unit 130 is, for example, a device such as a central processing unit (CPU), a graphics processing unit (GPU), or other programmable microprocessor.

More specifically, in the embodiment of FIG. 1B, as an example, the image capturing unit 120 is disposed at a lower side of the display area DA and configured to capture images from bottom to top along y-axis (i.e., the first direction D1), but the invention is not limited thereto. In other embodiments, the image capturing unit 120 can be disposed at an upper side of the display area DA (in this case, images are captured from top to bottom along y-axis), a left side of the display area DA (in this case, images are captured from front to back along z-axis), a right side (in this case, images are captured from back to front along z-axis) of the display area DA, or other positions located at a periphery of the display area DA, and the invention is not limited thereto.

Moreover, in the embodiment of FIG. 1B, although it is illustrated with first direction D1 being perpendicular to the normal direction ND of the display plane DP as an example, but the invention is not limited thereto. For instance, in other embodiments, the image capturing unit 120 can capture images along the first direction D1 which is any possible direction that is not parallel to the normal direction ND of the display plane DP. For instance, the first direction D1 can be any directions making the included angle AG to fall within a range of 60° to 90°.

In the present embodiment, the processor unit 130 is, for example, disposed together with image capturing unit 120 in the same device. The image information generated by the image capturing unit 120 is analyzed and processed by the processing unit 130, so as to obtain a coordinate of the object located in the sensing space. Afterwards, said device can transmit the coordinate of the object located in the sensing space to a host used in pair with the display unit 110 through wired or wireless transmissions. The host can convert the coordinate of the object located in the sensing space into a coordinate of the display unit 110, so as to control the frame of the display unit 110.

In other embodiments, the processing unit 130 can also be disposed in the host used in pair with the display unit 110. In this case, after the image information is obtained by the image capturing unit 120, the image information can be transmitted to the host through wired or wireless transmissions. The image information generated by the image capturing unit 120 is analyzed and processed by the host, so as to obtain a coordinate of the object located in the sensing space. The coordinate of the object located in the sensing space is then converted into a coordinate of the display unit 110, so as to control the frame of the display unit 110.

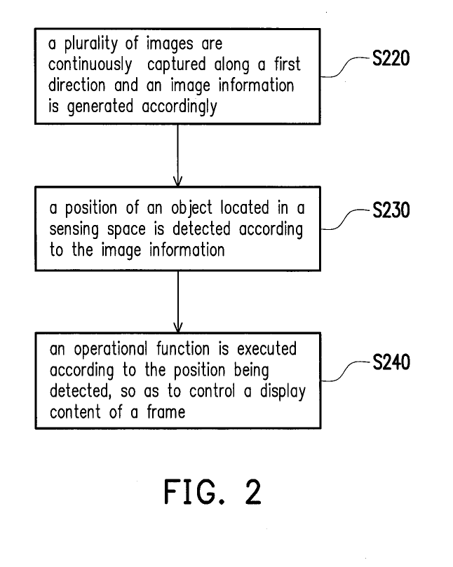

Detailed steps of an interactive sensing method are described below with reference to above system. FIG. 2 is a flowchart of an interactive sensing method according to an embodiment of the invention. Referring to FIG. 1A, FIG. 1B and FIG. 2 together. The image capturing unit 120 continuously captures a plurality of images along a first direction D1 and generates an image information of each of the images accordingly (step S220). The first direction D1 is not parallel to a normal direction ND of the display plane DP. In the present embodiment, it is illustrated with the first direction D1 being perpendicular to the normal direction ND of the display plane DP.

Next, the processing unit 130 detects a position of an object F located in a sensing space according to the image information (step S230), and executes an operational function according to the position being detected, so as to control a display content of a frame displayed on a display area DA (step S240).

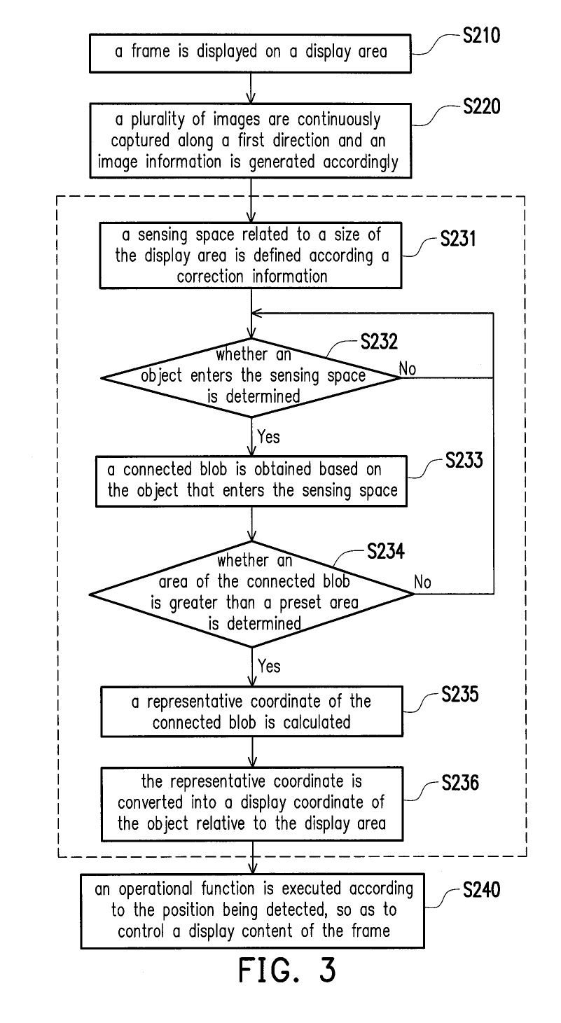

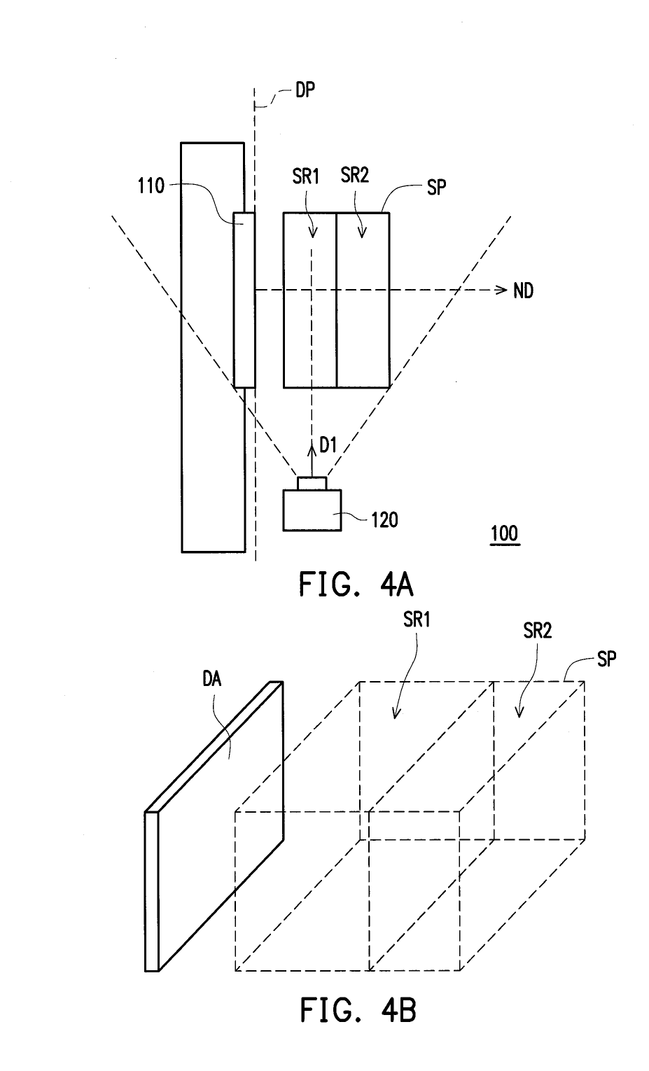

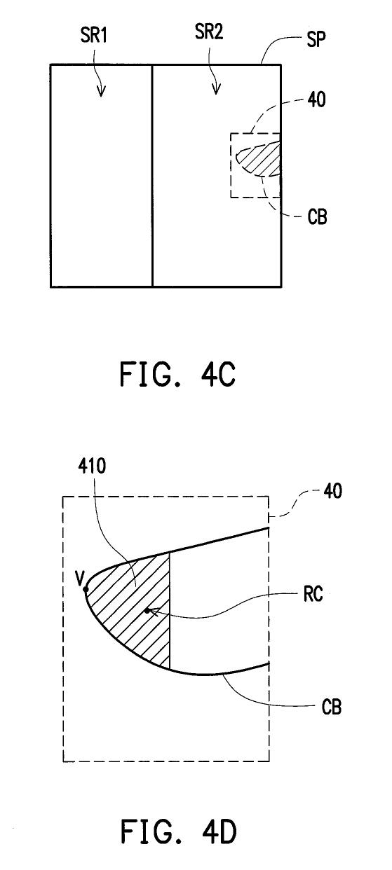

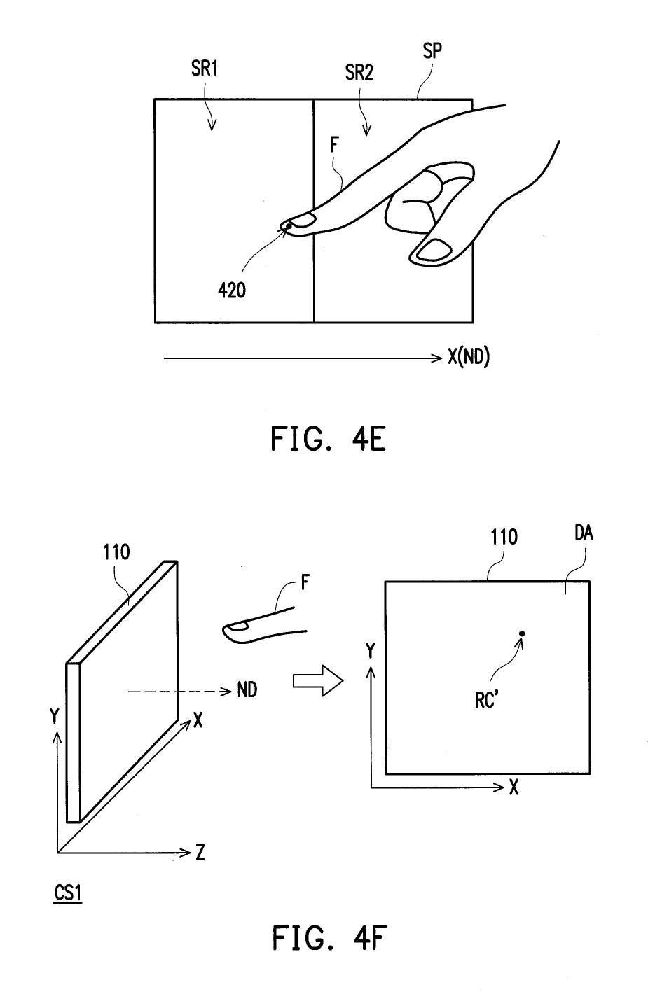

Another embodiment is provided below for further description. FIG. 3 is a flowchart of an interactive sensing method according to another embodiment of the invention. FIG. 4A to FIG. 4F are schematic diagrams illustrating operations of a three-dimensional interactive system according to an embodiment of the invention. In the present embodiment, the step (step S230) in which the object F is detected according to the image information can be realized by using steps S231 to S236 depicted in FIG. 3. Moreover, in the following embodiments, the object F is illustrated as the finger for examples, but the invention is not limited thereto. In other embodiments, the object F can also be a pen or other objects.

After the image information is generated by the image capturing unit 120 (step S220), the processing unit 130 can define a sensing space SP related to a size of the display area DA according a correction information (step S231), and the sensing space SP defined by the processing unit 130 is as shown in FIG. 4A and FIG. 4B.

Furthermore, in the step of defining the sensing space SP before detecting the position of the object F in the sensing space SP according to the image information, after an initial image information is obtained, the processing unit 130 can filter a non-operational region portion in the image information, and the sensing space can then be obtained according to the image information being filtered and the correction information. Herein, the non-operational region portion refers to, for example, an area which cannot be used by the user, such as a wall or a support bracket, configured to disposed the display unit 110 or configured to project the display frame.

For instance, in case the image capturing unit 120 is the depth camera, the image information obtained is a grey scale image. Accordingly, the processing unit 130 can determine whether a gradation block (i.e., the non-operational region portion) is existed in the image information, filter the gradation block, and define the sensing space according to the image information being filtered and the correction information. This is because the gradation block from shallow to deep in the depth camera is caused by shelters such as the wall, the support bracket or the screen.

Further, in other embodiments, the processing unit 130 can also filter the non-operational region portion by utilizing a method of removing background. For instance, the processing unit 130 can filter the non-operational region portion in the image information according to a background image (which can be established in the three-dimensional interactive system in advance). The background image is the image information excluding the object F and the shelters such as the wall, the support bracket or the screen. After the non-operational region portion in the image information is filtered, the processing unit 130 can further define the sensing space SP, as well as a first sensing region SR1 and a second sensing region SR2 therein, according to the correction information.

In the present embodiment, the second sensing region SR2 is closer to the display surface in comparison to the first sensing region SR1. Also, the user can perform upper, lower, left and right swings in the first sensing region SR1, and perform a clicking operation in the second sensing region SR2. Nevertheless, said embodiment is merely an example, and the invention is not limited thereto.

In an exemplary embodiment, the correction information can be, for example, a preset correction information stored in a storage unit (which is disposed in the three-dimensional interactive system 100 but not illustrated). The user can select a corresponding correction information in advance based on the size of the display area DA, so as define the sensing space SP having the corresponding size.

In another exemplary embodiment, the correction information can also be manually set by the suer according to the size of the display area DA. For instance, by clicking on four corners of the display area DA by the user, the processing unit 130 can obtain the image information containing positions of the four corners, and can define the sensing space SP having the corresponding size according to said image information as the correction information. In FIG. 4A and FIG. 4B, a small gap is provided between the sensing space SP and the display unit 110, but in other embodiments, the sensing space SP and the display unit can also be adjacent to each other without having any gap.

After the sensing space SP is defined, the processing unit 130 further determines whether the object F enters the sensing space SP (step S232). In other words, the image capturing unit 120 continuously captures images, and transmits the image information to the processing unit 130 for determining whether there is the object F that enters the sensing space SP. If the processing unit 130 determines that the object F enters the sensing space SP, the connected blob CB is obtained based on the object F that enters the sensing space SP (step S233). For instance, the processing unit 130 can find the connected blob CB by using a blob detect algorithm.

Hereinafter, for the convenience of the description, FIG. 4C is schematic diagram illustrated in a visual angle of the image capturing unit 120 from bottom to top, but FIG. 4C is not the image information actually obtained. Referring to FIG. 4C, in the present embodiment, the processing unit 130 is not limited to obtain only one single connected blob CB. When a plurality of objects F enter the sensing space at the same time, the processing unit 130 can also determine whether a plurality of connected blobs CB are existed, so as to realize an application in multi-touch.

After the connected blob CB is obtained, in order to avoid misjudgment, the processing unit 130 can determine whether an area of the connected blob CB is greater than a preset area (step S234). In case the processing unit 30 determines that the area of the connected blob CB is greater than the preset area, the processing unit 130 considers that the user intends to perform a controlling operation, such that a representative coordinate of the connected blob CB is calculated (step S235). Otherwise, in case the area of the connected blob CB is less than the preset area, it is considered that the user does not intend to perform the controlling operation, and proceeded back to step S232 in order to avoid an unwanted operation.

More specifically, referring to FIG. 4D, FIG. 4D illustrate an enlarged diagram of a block 40 depicted in FIG. 4C. In an exemplary embodiment, the processing unit 130 can detect a border position V (herein, it is illustrated as a foremost position of the connected blob CB for an example) of the connected blob CB according to the image information, and select a specific area proportion (e.g., 3% of the area of the connected blob CB) area among an area starting from the border position V towards a root portion of the connected blob CB to be served as a coordinate selecting area 410. In FIG. 4D, the coordinate selecting area 410 is illustrated in slashes. Next, the processing unit 130 calculates a coordinate at a center point of the coordinate selecting area 410 to be served as a representative coordinate RC of the connected blob CB. It should be noted that, a calculating method of the representative coordinate RC in the embodiments of the invention is not limited to the above. For instance, a position of an average of all the coordinates in the coordinate selecting area 410 can also be served as the representative coordinate.

Thereafter, the processing unit 130 converts the representative coordinate into a display coordinate of the object F relative to the display area (step S236). Next, an operational function is executed according to the position being detected (step S240). Namely, the corresponding operational function is executed according to the display coordinate of the object relative to the display area.

In addition, after the representative coordinate RC of the connected blob CB is calculated, the processing unit 130 can determine whether the object F is located in the first sensing region SR1 or the second sensing region SR2. Referring to FIG. 4E, FIG. 4E is a schematic diagram illustrating the user performing operations in the sensing space SP. Herein, a point 420 is served as the representative coordinate of the object F in the image information. By using the second sensing region SR2 as a clicking area for example, when it is detected that the point 420 (i.e., the representative coordinate) enters the second sensing region SR2 and leaves the second sensing region SR2 within a preset time, the clicking operation is then executed.

On the other hand, in FIG. 4F, a three-dimensional space coordinate system CS1 is a coordinate system defined by utilizing the image capturing unit 120 as a coordinate center, the normal direction ND as Z-axis, the first direction D1 as Y-axis and a direction perpendicular to both the normal direction ND and the first direction D1 as X-axis. With the configuration of FIG. 1B as an example, the image capturing unit 120 captures images from bottom to top, namely, the image information on XZ plane is thereby obtained. The processing unit 130 can convert the representative coordinate RC (X1, Z1) on XZ plane into the display coordinate RC′ (X2, Y2) relative to XY plane of the display area DA by utilizing the following formulae (1) and (2).

Y2=(Z1−K1)×F1 (1)

X2=Z1×F2−K2 (2)

Therein, F1, F2, K1 and K2 are constants which can be obtained by calculating said correction information.

After being converted by above formulae, the processing unit 130 can obtain the display area RC′ corresponding to the representative coordinate RC on the display area DA. In addition, when the user performs a dragging gesture along a specific direction, the processing unit 130 can also control a corresponding functional block in the frame to move with dragging of the user by detecting a moving trace of the display coordinate RC′.

Moreover, in practical applications, in order to improve accuracy in detecting the position of the object F, the processing unit 130 can also correct the moving trace of the representative coordinate RC according to the image information of frame period. For instance, the processing unit 130 can perform optimization and stabilization processes to the representative coordinate RC, so as the improve accuracy of the processing unit 130 in determinations. The stabilization is, for example, a smooth process. For instance, when previous and succeeding images shake dramatically due to influences of ambient light illumination, the smooth process can be performed, so that a trace of the object in the previous and succeeding images can be smoothed and stabilized.

Based on above, in the foregoing embodiments, the image capturing unit is disposed at a periphery of the display area to capture images near the display area, thereby detecting the position of the object. Accordingly, the three-dimensional interactive system is capable of effectively detecting the controlling operations of the user in the areas closing to the display area, for improving limitation of controlling distance in conventional three-dimensional interactive system, such that an overall controlling performance can be further improved.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A three-dimensional interactive system, configured to control a display content of a frame of a display unit, wherein the display unit comprises a display area displaying the frame and located on a display plane, and the three-dimensional interactive system comprises:
an image capturing unit disposed at a periphery of the display area, and configured to continuously capture a plurality of images along a first direction and generate an image information of each of the images accordingly, wherein the first direction is not parallel to a normal direction of the display plane; and
a processing unit coupled to the display unit and the image capturing unit, and configured to detect a position of an object located in a sensing space according to the image information and execute an operational function to control the display content according to the position being detected.

2. The three-dimensional interactive system of claim 1, wherein the processing unit defines the sensing space related to a size of the display area according to a correction information, wherein the sensing space is divided into a first sensing region and a second sensing region along the normal direction of the display plane.

3. The three-dimensional interactive system of claim 2, wherein the processing unit detects whether the object enters the sensing space, and obtains a connected blob based on the object that enters the sensing space.

4. The three-dimensional interactive system of claim 3, wherein the processing unit determines whether an area of the connected blob is greater than a preset area, calculates a representative coordinate of the connected blob if the processing unit determines that the area of the connected blob is greater than the preset area, and converts the representative coordinate into a display coordinate of the object relative to the display area.

5. The three-dimensional interactive system of claim 4, wherein the processing unit determines whether the object is located in the first sensing region or the second sensing region according to the representative coordinate, thereby executing the corresponding operational function.

6. The three-dimensional interactive system of claim 1, wherein the processing unit filters a non-operational region portion in the image information according to a background image, and obtains the sensing space according to the image information being filtered.

7. The three-dimensional interactive system of claim 1, wherein the image capturing unit is a depth camera, and the image information is a grey scale image,
wherein the processing unit determines whether a gradation block is existed in the image information, filters the gradation block, and obtains the sensing space according to the image information being filtered.

8. The three-dimensional interactive system of claim 1, wherein an included angle between the first direction and the normal direction falls within an angle range, wherein the angle range is decided based on a lens type of the image capturing unit.

9. The three-dimensional interactive system of claim 8, wherein the angle range is 45 degrees to 135 degrees.

10. An interactive sensing method, comprising:
continuously capturing a plurality of images along a first direction and generating an image information of each of the images accordingly, wherein the first direction is not parallel to a normal direction of a display plane, and a display area is located on the display plane for displaying a frame;
detecting a position of an object located in a sensing space according to the image information; and
executing an operational function to control the display content of the frame according to the position being detected.

11. The interactive sensing method of claim 10, wherein before detecting the position of the object located in the sensing space according to the image information, further comprising:
defining the sensing space related to a size of the display area according to a correction information after the image information is obtained, wherein the sensing space is divided into a first sensing region and a second sensing region along the normal direction of the display plane.

12. The interactive sensing method of claim 11, wherein detecting the position of the object located in the sensing space according to the image information comprises:
detecting whether the object enters the sensing space according to the image information;
obtaining a connected blob based on the object that enters the sensing space when the object that enters the sensing space is detected;
determining whether an area of the connected blob is greater than a preset area;
calculating a representative coordinate of the connected blob if the area of the connected blob is greater than the preset area; and
converting the representative coordinate into a display coordinate of the object relative to the display area.

13. The interactive sensing method of claim 12, wherein after calculating the representative coordinate of the connected blob, further comprising:
determining whether the object is located in the first sensing region or the second sensing region according to the representative coordinate, thereby executing the corresponding operational function.

14. The interactive sensing method of claim 10, wherein before detecting the position of the object located in the sensing space according to the image information, further comprising:
filtering a non-operational region portion in the image information after the image information is obtained; and
obtaining the sensing space according to the image information being filtered.

15. The interactive sensing method of claim 14, wherein the image capturing unit is a depth camera, and the image information is a grey scale image,
wherein filtering the non-operational region portion in the image information comprises:
determining whether a gradation block is existed, and filtering the gradation block.

16. The interactive sensing method of claim 10, wherein an included angle between the first direction and the normal direction falls within an angle range, wherein the angle range is decided based on a lens type of the image capturing unit.

17. The interactive sensing method of claim 16, wherein the angle range is 45 degrees to 135 degrees.
